(19) United States
(12) Patent Application Publication
(10) Pub. No.: US 2019/0197738 A1
(43) Pub. Date: Jun. 27, 2019

(54) IMAGE PROCESSING DEVICE, IMAGE PROCESSING SYSTEM, RECORDING MEDIUM AND LABEL

(71) Applicant: SUMITOMO ELECTRIC INDUSTRIES, LTD., Osaka-shi, Osaka (JP)

(72) Inventors: Yuri KISHITA, Osaka-shi, Osaka (JP); Michikazu UMEMURA, Osaka-shi, Osaka (JP)

(73) Assignee: SUMITOMO ELECTRIC INDUSTRIES, LTD., Osaka-shi, Osaka (JP)

(21) Appl. No.: 16/322,252

(22) PCT Filed: Apr. 14, 2017
(86) PCT No.: PCT/JP2017/015266

§ 371 Date: Jan. 31, 2019

(30) Foreign Application Priority Data
Sep. 1, 2016 (JP) 2016-170638

(51) Int. Cl. G06T 7/90; G01J 3/50; G01J 3/46; G01V 8/10; B66F 9/24; G06T 7/70; B60Q 9/00

(52) U.S. Cl. CPC G06T 7/90; G01J 3/50; G01J 3/463; B60Q 9/00; B66F 9/24; G06T 7/70; G01V 8/10

(57) ABSTRACT

An image processing device is equipped with an image acquisition section for acquiring an image taken by an imaging section mounted on a vehicle categorized as an industrial vehicle or a vehicle-type construction machine; a judgement section for performing judgment processing as to whether predetermined two or more color areas having a predetermined positional relationship are included in the image taken by the image acquisition section; and a notification section for performing notification processing depending on the result of the judgment processing of the judgement section.

### TECHNICAL FIELD

This disclosure relates to an image processing device, an image processing system, an image processing program, and a label.

The present application claims priority on the basis of Japanese Patent Application No. 2016-170638 filed on Sep. 1, 2016, and all the contents described in the above-mentioned Patent Application are incorporated for reference.

### BACKGROUND ART

Conventionally, forklifts have been used for cargo handling in facilities, such as warehouses, factories or airports. Patent Document 1 discloses a person detection system for construction machines to detect persons being present around vehicle-type construction machines. According to Patent Document 1, an image taken by a camera installed on a shovel serving as a vehicle-type construction machine is used to detect a person being present around the shovel. More specifically, according to Patent Document 1, an HOG (Histograms of Oriented Gradients) feature amount is extracted from the image, and the candidate area of the person is identified from the extracted HOG feature amount. Furthermore, after the image of the candidate area of the person is converted into an image as viewed just from the front, the area of the helmet is extracted using the luminance gradient or the like of the pixels included in the image.

Furthermore, Patent Document 2 discloses a safety device for a forklift to detect a person being present around the forklift. Shapes being mutually different are drawn with a predetermined color on the forklift and a person, and the forklift and the person are imaged by a fixed camera having been preliminarily installed on the ceiling. The safety device extracts the above-mentioned shapes from the obtained image and detects the forklift and the person; in the case that the forklift and the person approach each other within a certain distance, the safety device issues a warning.

### PRIOR ART DOCUMENT

### Patent Document

Patent Document 1: International Publication No. WO 2015/186570

Patent Document 2: Japanese Patent Application Laid-Open Publication No. H09-169500

### SUMMARY OF THE INVENTION

(1) An image processing device according to this disclosure is equipped with an image acquisition section for acquiring an image taken by an imaging section mounted on a vehicle categorized as an industrial vehicle or a vehicle-type construction machine; a judgement section for performing judgment processing as to whether predetermined two or more color areas having a predetermined positional relationship are included in the image taken by the image acquisition section; and a notification section for performing notification processing depending on the result of the judgment processing of the judgement section.

(8) An image processing system according to this disclosure is equipped with a label, which is placed on an object to be detected and on which predetermined two or more color areas are disposed in a predetermined positional relationship, and an image processing device for detecting the object to be detected, wherein the image processing device has an image acquisition section for acquiring an image taken by an imaging section mounted on a vehicle categorized as an industrial vehicle or a vehicle-type construction machine; a judgement section for performing judgment processing as to whether the predetermined two or more color areas are included in the image taken by the image acquisition section; and a notification section for giving a notification depending on the result of the judgment processing of the judgement section.

(9) An image processing program according to this disclosure makes a computer function as an image acquisition section for acquiring an image taken by an imaging section mounted on a vehicle categorized as an industrial vehicle or a vehicle-type construction machine; a judgement section for performing judgment processing as to whether predetermined two or more color areas are included in the image taken by the image acquisition section; and a notification section for performing notification processing depending on the result of the judgment processing of the judgement section.

(10) A label according to this disclosure is subjected to judgment processing by the above-mentioned image processing device as to whether predetermined two or more color areas are included, wherein the predetermined two or more color areas are disposed in a predetermined positional relationship.

This disclosure can be attained not only as an image processing device equipped with these characteristic processing sections but also as an image processing method wherein the processing to be performed by the characteristic processing sections included in the image processing device is performed stepwise. Furthermore, it is needless to say that the above-mentioned image processing program can be distributed on computer-readable non-transitory recording media, such as a CD-ROM (Compact Disc-Read Only Memory), or a communication network, such as the Internet. Moreover, this disclosure can also be attained such that part or whole of the image processing device is implemented as a semiconductor integrated circuit.

### BRIEF DESCRIPTION OF THE DRAWINGS

FIG. 1 is a view showing an installation example of an image processing system according to Embodiment 1;

FIG. 2 is a block diagram showing a functional configuration of the image processing system according to Embodiment 1;

FIG. 3 is a schematic view showing a forklift as viewed from above;

FIG. 4A is a side view showing a helmet worn by a person;

FIG. 4B is a top view showing the helmet worn by the person;

FIG. 5 is a view showing expressions in the Munsell color system for respective color labels;

FIG. 6A is a view showing an example of a green area and a red area on an image;

FIG. 6B is a view showing an example of a green area and a red area on an image;

FIG. 7 is a view showing an example of an image taken by a rearward monitoring camera;

FIG. 8 is a flow chart of the processing performed by an image processing device according to Embodiment 1;

FIG. 9 is a flow chart showing the details of threshold value setting processing (at S4 of FIG. 8);

FIG. 10 is a side view showing a helmet worn by a person;

FIG. 11 is a side view showing a helmet worn by a person;

FIG. 12 is a side view showing a helmet worn by a person;

FIG. 13 is a front view of a person;

FIG. 14 is a block diagram showing a functional configuration of an image processing system according to Embodiment 2;

FIG. 15 is a flow chart of the processing performed by an image processing device according to Embodiment 2;

FIG. 16 is a block diagram showing a functional configuration of an image processing system according to Embodiment 3;

FIG. 17 is a flow chart of the processing performed by an image processing device according to Embodiment 3;

FIG. 18 is a figure showing an example of a data table indicating the relationship between positions being held in a threshold value setting section and the threshold values of green areas;

FIG. 19 is a view showing an installation example of an image processing system according to Embodiment 4;

FIG. 20 is a block diagram showing a functional configuration of the image processing system according to Embodiment 4;

FIG. 21 is a schematic view showing the forklift as viewed from above; and

FIG. 22 is a flow chart of the processing performed by an image processing device according to Embodiment 4.

### MODE FOR CARRYING OUT THE INVENTION

[Problem that the Invention is to Solve]

Since a forklift is structured such that a load is placed in an overhung state, the weight of the vehicle body is heavier than it looks. Hence, even if the forklift travels at low speed, the vehicle may make contact with a person, and there is a high possibility of causing a serious accident. This kind of problem will occur not only in industrial vehicles typified by a forklift but also in vehicle-type construction machines, such as a hydraulic shovel.

In Patent Document 1, since the candidate area of a person is identified using an HOG feature amount, in the case that the person squats or falls down, the candidate area of the person cannot be identified accurately. Furthermore, when a helmet is extracted, the image of the candidate area of the person is converted into an image as viewed just from the front. Hence, in the case that the person squats or falls down, the area of the helmet cannot be extracted accurately. As described above, the system described in Patent Document 1 has a problem of being weak against posture change.

In the safety device described in Patent Document 2, since it is assumed that the camera thereof is fixed to the ceiling, the device has a problem of being unable to detect a person in the case that the forklift travels at a position where the camera is not installed.

Accordingly, the present invention is intended to provide an image processing device, an image processing system and an image processing program being strong against the posture change of a person and capable of detecting a person being present around a vehicle at an arbitrary position where a vehicle categorized as an industrial vehicle or a vehicle-type construction machine travels. The present invention is also intended to provide a label that is detected accurately by image processing.

### [Advantage of the Invention]

This disclosure can provide an image processing device, an image processing system and an image processing program being strong against the posture change of a person and capable of detecting a person being present around a vehicle at an arbitrary position where a vehicle categorized as an industrial vehicle or a vehicle-type construction machine travels.

Furthermore, this disclosure can also provide a label that is detected accurately by image processing.

### [Summary of an Embodiment According to the Present Application]

First, a summary of an embodiment will be enumerated and described.

(1) An image processing device according to this embodiment is equipped with an image acquisition section for acquiring an image taken by an imaging section mounted on a vehicle categorized as an industrial vehicle or a vehicle-type construction machine; a judgement section for performing judgment processing as to whether predetermined two or more color areas having a predetermined positional relationship are included in the image taken by the image acquisition section; and a notification section for performing notification processing depending on the result of the judgment processing of the judgement section.

With this configuration, a judgment is made as to whether the predetermined two or more color areas having the predetermined positional relationship are included in the image taken by the imaging section mounted on a vehicle categorized as an industrial vehicle or a vehicle-type construction machine, and a notification depending on the result of the judgment processing can be given. Hence, by attaching a label having the predetermined two or more color areas to a person or the helmet worn by the person, the person can be detected. The processing for extracting these color areas can be performed in the case that the color areas are imaged by the imaging section. Hence, the image processing device is strong against the posture change of a person and can detect a person around the vehicle at an arbitrary position where the vehicle travels.

(2) Furthermore, the imaging section may include a rearward monitoring camera, which is installed at the position on the vehicle where the area behind the vehicle is allocated as the imaging area thereof; the image acquisition section may acquire the image of the area behind the vehicle taken by the rearward monitoring camera; and the judgement section may stop the judgment processing for the image of the area behind the vehicle in the case that the vehicle is traveling forward.

With this configuration, the area behind the vehicle and the areas around the sides of the vehicle are in the blind spots of the driver. Hence, a person being present in such a blind spot can be detected by performing judgment processing for the image of the area behind the vehicle taken by the rearward monitoring camera. Furthermore, in the case that a person is present in the blind spot, a notification can be given to the driver appropriately. Moreover, also in the case that the vehicle starts, there is a high possibility that the vehicle will make contact with a person. Hence, in the case that a person is present in the blind spot of the driver immediately before the forklift starts, a notification can be given to the driver appropriately by performing the judgment processing and notification processing in the case that the vehicle is stopping. Consequently, the vehicle can be prevented preliminarily from making contact with the person being present around the vehicle. In the case that the vehicle is traveling forward, the driver drives carefully, whereby it is not particularly necessary to monitor the area behind the vehicle. With this configuration, the judgment processing is stopped in the case that the vehicle travels forward. As a result, the fact that a person has been detected can be prevented from being unnecessarily notified to the driver.

(3) Moreover, the imaging section may further include a forward monitoring camera, which is installed at the position on the vehicle where the area ahead of the vehicle is allocated as the imaging area thereof; the image acquisition section may further acquire the image of the area ahead of the vehicle taken by the forward monitoring camera; and the judgement section may further perform the judgment processing for the image of the area ahead of the vehicle in the case that the vehicle is traveling forward.

With this configuration, in the case that the vehicle travels forward, the judgment processing is performed for the image of the area ahead of the vehicle taken by the forward monitoring camera. Hence, a person being present ahead of the vehicle can be detected. Furthermore, in the case that a person is present ahead of the vehicle, a notification can be given to the driver appropriately. Consequently, the vehicle can be prevented preliminarily from making contact with the person being present around the vehicle.

(4) What's more, the judgement section may include a color extraction section for extracting the predetermined two or more color areas on the basis of pixel values on a predetermined color space and of the respective pixels constituting the image and predetermined threshold values; the image acquisition section may acquire an image, taken by the imaging section, of a reference label having the predetermined two or more colors and placed at a predetermined position of the vehicle; and the image processing device may be further equipped with a threshold value setting section for setting the predetermined threshold values on the basis of the pixel values on the color space and of the image of the reference label.

With this configuration, the threshold values can be set on the basis of the pixel values of the reference label disposed in an environment similar to those of labels placed on a person and a helmet to be detected. Hence, the threshold values can be set accurately, whereby the areas can be extracted accurately.

(5) Still further, the threshold value setting section may set the predetermined threshold values in the case that a change in illuminance around the vehicle is detected.

By setting the threshold values in the case that the change in illuminance is detected as described above, the areas can be extracted accurately even in the case that the environment around the vehicle has changed.

(6) Furthermore, the judgement section may include a color extraction section for extracting the predetermined two or more color sections on the basis of the values on a predetermined color space and of the respective pixels constituting the image and predetermined threshold values, and the image processing device may be further equipped with a threshold value setting section for setting the predetermined threshold values on the basis of the position of the vehicle.

With this configuration, the threshold values can be set on the basis of the position of the vehicle. For example, by preliminarily associating the position of the vehicle with the threshold values, the threshold values in the case that the vehicle is traveling indoors can be changed so as to be different from the threshold values in the case that the vehicle is traveling outdoors. Hence, the areas can be extracted accurately even in the case that the environment around the vehicle has changed.

(7) Moreover, of the images acquired by the image acquisition section, the image of a mirror area that is taken by imaging the mirror installed on the vehicle may be subjected to the judgment processing by the judgement section.

With this configuration, even in the case that a person is shown over the mirror that is installed on the vehicle to confirm the blind spot, the judgment processing is performed for the image of the person. Hence, the person being present in the blind spot area can be detected accurately.

(8) An image processing system according to the embodiment is equipped with a label, which is placed on an object to be detected and on which predetermined two or more color areas are disposed in a predetermined positional relationship, and an image processing device for detecting the object to be detected, wherein the image processing device has an image acquisition section for acquiring an image taken by an imaging section mounted on a vehicle categorized as an industrial vehicle or a vehicle-type construction machine; a judgement section for performing judgment processing as to whether the predetermined two or more color areas are included in the image taken by the image acquisition section; and a notification section for giving a notification depending on the result of the judgment processing of the judgement section.

With this configuration, the label having the predetermined two or more color areas is placed on an object to be detected, such as a person. Furthermore, the image processing device can judge whether the predetermined two or more color areas are included in the image taken by the imaging section mounted on the vehicle categorized as an industrial vehicle or a vehicle-type construction machine and can give a notification depending on the result of the judgment processing. The processing for extracting these color areas can be performed in the case that the color areas are imaged by the imaging section. Hence, the image processing device is strong against the posture change of a person and can detect a person being present around the vehicle at an arbitrary position where the vehicle travels.

(9) An image processing program according to the embodiment makes a computer function as an image acquisition section for acquiring an image taken by an imaging section mounted on a vehicle categorized as an industrial vehicle or a vehicle-type construction machine, a judgement section for performing judgment processing as to whether predetermined two or more color areas are included in the image taken by the image acquisition section, and a notification section for performing notification processing depending on the result of the judgment processing of the judgement section.

With this program, the computer can be made to function as the above-mentioned image processing device. Hence, operations and effects similar to those of the above-mentioned image processing device can be attained.

(10) A label according to the embodiment is subjected to judgment processing by the above-mentioned image processing device as to whether predetermined two or more color areas are included, wherein the predetermined two or more color areas are disposed in a predetermined positional relationship.

With this configuration, the predetermined two or more color areas are disposed in the predetermined positional relationship on the label. Hence, by placing the label on an object to be detected, such as a person, the object to be detected can be detected accurately by the above-mentioned image processing device.

(11) Moreover, a predetermined clearance may be provided between the respective color areas.

With this configuration, even in the case that disturbances occur in an image taken by the imaging section due to vibrations and the like during the traveling of the vehicle, the color of an area can be prevented from being mixed with the color of the area adjacent thereto. Consequently, an object to be detected can be detected accurately by the above-mentioned image processing device.

(12) What's more, the respective color areas may be composed of fluorescent tapes, fluorescent paint or light emitting elements.

Hence, the label can be made easily recognizable even under environments in which illuminance is low, for example, at night or in cloudy weather.

### [Details of Embodiments According to the Present Invention]

Embodiments according to this disclosure will be described below in detail using drawings. The embodiments to be described below are all desirable examples of this disclosure. The numerical values, the shapes, the materials, the components, the arrangement positions and connection modes of the components, the steps, the sequence of the steps, etc. to be described in the following embodiments are taken as examples and are not intended to limit this disclosure. This disclosure is specified by the claims. Hence, of the components according to the following embodiments, the components not described in the independent claims representing the highest concepts of the present invention are not necessarily required to attain the tasks of this disclosure, but they are described as components constituting further preferable modes.

### Embodiment 1

An image processing system according to Embodiment 1 will be described below.

### <Configuration of the Image Processing System>

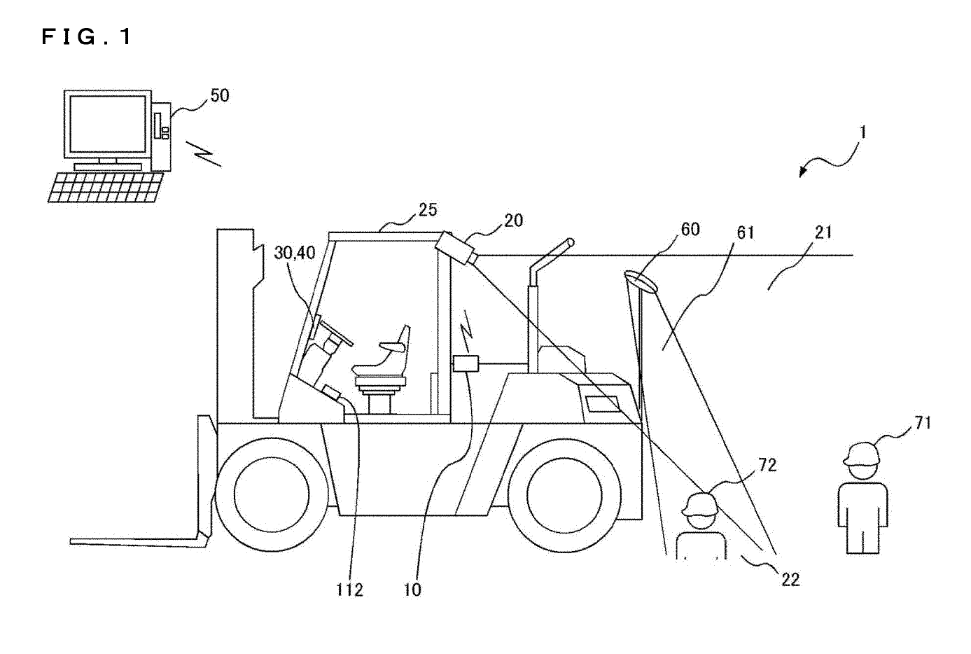

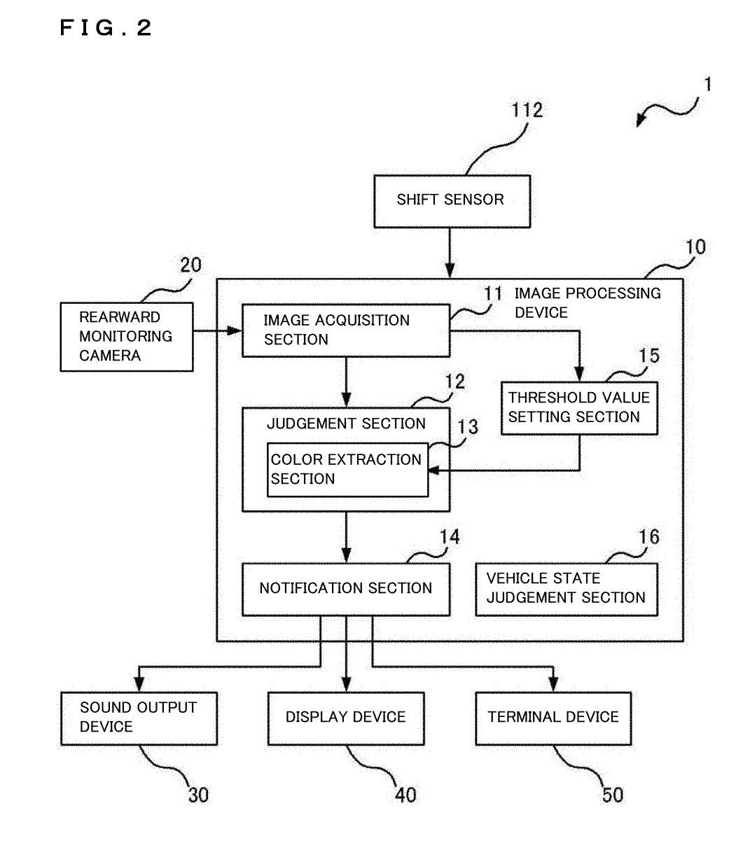

FIG. 1 is a view showing an installation example of the image processing system according to Embodiment 1. FIG. 2 is a block diagram showing a functional configuration of the image processing system according to Embodiment 1.

An image processing system 1 is a system for monitoring the periphery of a forklift 25 and is equipped with a rearward monitoring camera 20, an image processing device 10, a sound output device 30, a display device 40, a terminal device 50, and a shift sensor 112. The configuration of the image processing system 1 shown in FIGS. 1 and 2, however, is just an example, and the image processing system 1 may not be equipped with either one of the sound output device 30, the display device 40 and the terminal device 50.

In addition, a vehicle in which the image processing device 10, the rearward monitoring camera 20, the sound output device 30, the display device 40 and the shift sensor 112 are installed is not limited to the forklift 25; these devices may be installed in industrial vehicles other than the forklift 25 or may also be installed in vehicle-type construction machines, such as a hydraulic shovel. In the case that the rearward monitoring camera 20 is installed in these vehicles, the camera can monitor the peripheries of these vehicles.

The rearward monitoring camera 20 constituting an imaging section is installed, for example, at a position where the area behind the forklift 25 can be imaged (for example, at the rear end position of the fork head guard of the forklift 25) and is used to take an image of the area behind the forklift 25. The camera lens of the rearward monitoring camera 20 is, for example, a super-wide angle lens having a field angle of 120° or more.

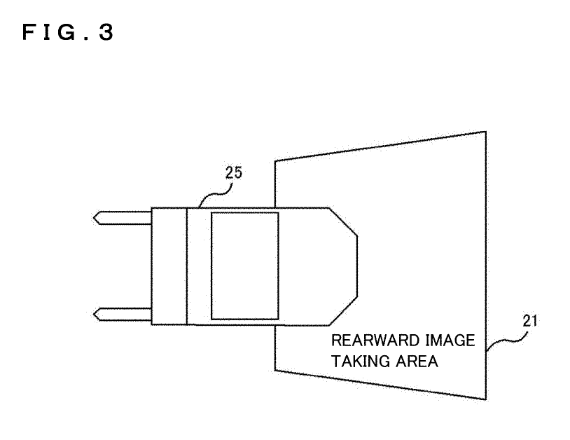

FIG. 3 is a schematic view showing the forklift 25 as viewed from above. In FIG. 3, the left side is the area ahead of the forklift 25, and the right side is the area behind the forklift 25. As shown in FIG. 3, a rearward image taking area 21 to be monitored by the rearward monitoring camera 20 is set behind the forklift 25. This rearward image taking area 21 is set, for example, so as to include the movable range of the forklift 25 in two seconds in the case that the forklift 25 travels at the maximum speed of 10 km/h. In other words, the rearward monitoring camera 20 is set at the position where the image of the rearward image taking area 21 can be taken. Hence, the rearward monitoring camera 20 can take the image of a person 71 being present inside the rearward image taking area 21. The reason for this setting of the rearward image taking area 21 is that it is assumed that the driver can stop the forklift 25 within two seconds after the driver found the person 71. Although a monocular camera is assumed to be used as the rearward monitoring camera 20, a multiple camera, such as a stereo camera, may also be used.

A blind spot area 22 deviated from the rearward image taking area 21 of the forklift 25 may be generated sometimes behind the forklift 25. A mirror 60 is installed inside the rearward image taking area 21 of the forklift 25 in order to cover this blind spot area 22. In other words, the rearward monitoring camera 20 can take the image of a person 72 being present in the blind spot area 22 by disposing the mirror 60 so that a rearward image taking area 61 covers the blind spot area 22 in the case that the rearward monitoring camera 20 takes an image over the mirror 60. Instead of the mirror 60, another camera different from the rearward monitoring camera 20 may also be disposed to take the image of the blind spot area 22.

The image processing device 10 is a computer installed in the forklift 25. The image processing device 10 is connected to the rearward monitoring camera 20 and detects the persons 71 and 72 from the images of the rearward image taking areas 21 and 61 taken by the rearward monitoring camera 20. In this embodiment, it is assumed that labels are attached to the persons 71 and 72, each label being surely provided with predetermined two or more color areas that are disposed in a predetermined positional relationship.

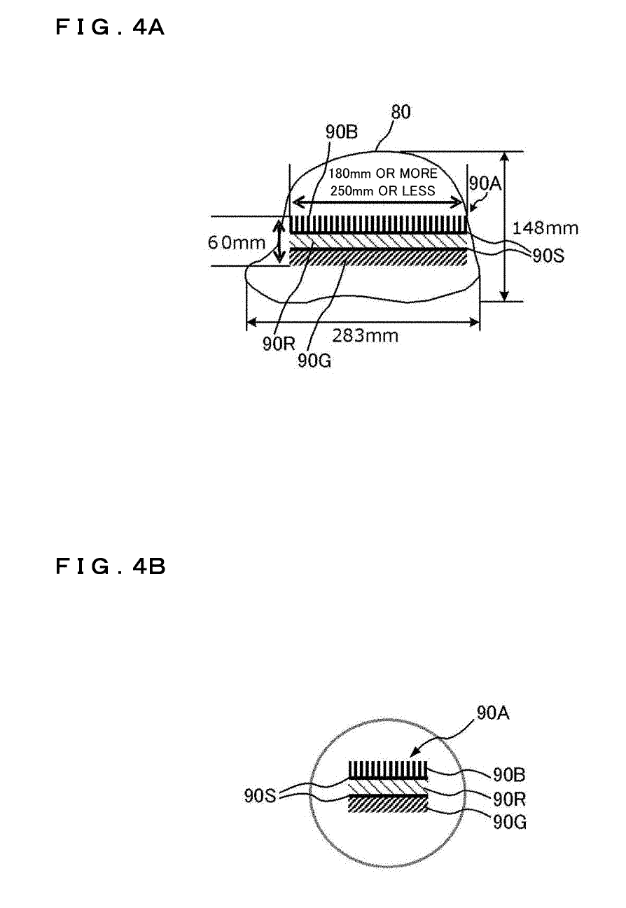

FIG. 4A is a side view showing a helmet worn by a person, and FIG. 4B is a top view showing the helmet. As shown in FIGS. 4A and 4B, labels 90A are attached to a helmet 80. The label 90A is composed of a blue label 90B, a red label 90R and a green label 90G being arranged in parallel. As shown in FIG. 4A, in the case that the width of the helmet 80 is 283 mm and the height thereof is 148 mm, the width of the label 90A can be set to approximately 60 mm and the length thereof can be set to approximately 180 mm or more and 250 mm or less. A clearance area 90S is provided between the blue label 90B and the red label 90R and is also provided between the red label 90R and the green label 90G. The clearance area 90S is, for example, a black area and has a width of 2 to 3 mm. As shown in FIG. 4B, a similar label 90A is also attached to the upper side of the helmet 80. Furthermore, the labels 90A are also attached to the opposite side face and the front and rear sides of the helmet 80. Since the labels 90A are attached to all the positions as described above, the image of any one of the labels 90A can be taken by the rearward monitoring camera 20 even if the person takes any posture (standing upright, squatting, etc.).

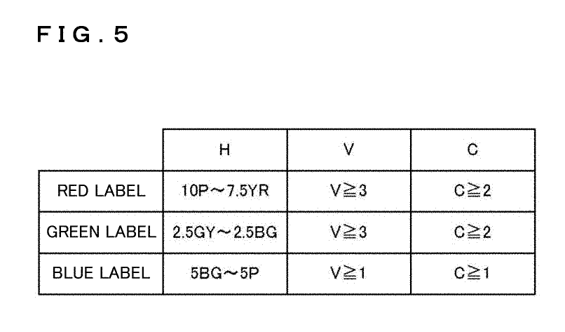

The label 90A is composed the red label 90R, the green label 90G and the blue label 90B having three primary colors of light. FIG. 5 is a view showing expressions in the Munsell color system (JISZ 8721) for the respective color labels. In the figure, H, V and C represent hue, value and chroma, respectively. In other words, the color of the red label 90R has the hue (H) in a range of 10P to 7.5YR, the value (V) in a range of 3 or more, and the chroma (C) in a range of 2 or more in the Munsell color system. The color of the green area 90G has the hue (H) in a range of 2.5GY to 2.5BG, the value (V) in a range of 3 or more, and the chroma (C) in a range of 2 or more in the Munsell color system. The color of the blue label 90B has the hue (H) in a range of 5BG to 5P, the value (V) in a range of 1 or more, and the chroma (C) in a range of 1 or more in the Munsell color system. However, the label 90A is not limited to be composed of labels having three primary colors of light but may be composed of labels having other colors.

Furthermore, it is preferable that the blue label 90B, the red label 90R and the green label 90G should be composed of fluorescent tapes or these labels should be coated with fluorescent paint. In this case, the labels can be made easily recognizable even under environments in which illuminance is low, for example, at night or in cloudy weather. Moreover, the labels can be recognized without using a special camera, such as an infrared camera.

The image processing device 10 detects the label 90A from the image taken by the rearward monitoring camera 20, thereby detecting a person. The detailed configuration of the image processing device 10 will be described later.

The sound output device 30 is installed, for example, in the vicinity of the driver's seat of the forklift 25 and is configured so as to include a speaker. The sound output device 30 is connected to the image processing device 10 and outputs a notification sound in order to notify the driver that the image processing device 10 has detected the person 71 or the person 72.

The display device 40 is installed at a position where the driver of the forklift 25 can visually recognize the display device and is configured so as to include, for example, a liquid crystal display. The display device 40 is connected to the image processing device 10 and displays an image in order to notify that the image processing device 10 has detected the person 71 or the person 72.

The terminal device 50 is a computer that is installed at a place away from the forklift 25, such as a control room for controlling the forklift 25. The terminal device 50 is connected to the image processing device 10 and outputs a sound or an image in order to notify that the image processing device 10 has detected the person 71 or the person 72, or records the fact that the image processing device 10 has detected the person 71 or the person 72 together with time information as log information. The terminal device 50 and the image processing device 10 may be mutually connected by a mobile telephone line according to a communication standard, such as 4G, or a wireless LAN (Local Area Network), such as Wi-Fi (registered trademark).

The terminal device 50 may be, for example, a smart phone carried by the person 71 or the person 72. In this case, the person 71 or the person 72 can be notified that he has been detected by the image processing device 10, that is, the forklift 25 is present nearby.

Furthermore, the functions of the image processing device 10, the rearward monitoring camera 20, the sound output device 30 and the display device 40 may be provided for, for example, a smart phone or a camera-equipped computer. For example, by installing a smart phone at the position where the rearward monitoring camera 20 shown in FIG. 1 is installed, the smart phone processes the image taken by the smart phone and detects the person 71 or the person 72. Furthermore, the smart phone notifies the result of the detection by a sound or an image. However, in the case that the smart phone is installed at the position where the rearward monitoring camera 20 is installed, the driver cannot see the image. Hence, it may be possible that another tablet device or the like is installed at a position that can be visually recognized by the driver and that the tablet device displays the image transmitted from the smart phone. The tablet device and the smart phone may be mutually connected wirelessly according to a wireless communication standard, such as Wi-Fi (registered trademark), Bluetooth (registered trademark) or Zigbee (registered trademark).

Referring to FIGS. 1 and 2, the shift sensor 112 is installed in the vicinity of the shift lever and serves as a sensor for detecting the position of the shift lever. The shift sensor 112 is configured so as to include, for example, a displacement sensor or a switch.

### <Configuration of the Image Processing Device 10>

Referring to FIG. 2, the functional configuration of the image processing device 10 will be described in more detail.

The image processing device 10 is composed of a general-purpose computer that is equipped with a CPU (Central Processing Unit), RAM (Random Access Memory), ROM (Read Only Memory), HDD (Hard Disk Drive), a communication I/F (interface), a timer, etc. The image processing device 10 is equipped with an image acquisition section 11, a judgment section 12, a color extraction section 13, a notification section 14, a threshold value setting section 15, and a vehicle state judgment section 16 as functional components implemented by executing a computer program having been read from the HDD or the ROM to the RAM.

The image acquisition section 11 acquires images taken by the rearward monitoring camera 20 via the communication I/F. In other words, the images of the rearward image taking areas 21 and 61 shown in FIG. 1 taken by the rearward monitoring camera 20 are acquired.

The judgement section 12 judges whether the predetermined two or more color areas (herein, the green area, the red area and the blue area) are included in the images acquired by the image acquisition section 11.

More specifically, the judgement section 12 includes the color extraction section 13. The color extraction section 13 extracts the green area, the red area and the blue area on the basis of pixel values on a color space and of the respective pixels constituting the image acquired by the image acquisition section 11 and predetermined threshold values. Herein, an HSV color space is assumed as the color space. Furthermore, the hue (H), the saturation (S) and the value (V) are assumed as the pixel values on the HSV color space.

In the case that the image acquired by the image acquisition section 11 is composed of pixel values of an RGB color space, the color extraction section 13 converts the pixel values of the RGB color space into the pixel values of the HSV color space and performs area extraction processing. The conversion from the pixel values of the RGB space into the pixel values of the HSV color space is performed, for example, by formulas 1 to 3 described below.

$$\begin{matrix}H = \{ \begin{matrix}60 \times \frac{G - B}{MAX - MIN} & if MAX = R \\ 60 \times \frac{B - R}{MAX - MIN} + 120 & if MAX = G \\ 60 \times \frac{R - G}{MAX - MIN} + 240 & if MAX = B\end{matrix} & ( 1 ) \\ S = \frac{MAX - MIN}{MAX} & ( 2 ) \\ V = MAX & ( 3 )\end{matrix}$$

R, G and B herein respectively represent the red component, the green component and the blue component of the pixel before the conversion. Furthermore, MAX and MIN respectively represent the maximum value and the minimum value of the red components, the green components and the blue components of the pixels before the conversion.

It is assumed that, to the color extraction section 13, for example, a range of 120±25 has been set as the range of the hue (H) of green, a range of 70 or more to 100 or less has been set as the range of the saturation (S) of green, and a range of 70 or more to 100 or less has been set as the range of the value (V) of green. In the case of a pixel having the hue (H) in the range of 120−25 or more to 120+25 or less, having the saturation (S) in the range of 70 or more to 100 or less and having the value (V) in the range of 70 or more to 100 or less, the color extraction section 13 extracts the pixel as a green pixel. Similarly, the color extraction section 13 extracts a red pixel from the image using the threshold values of the hue (H), the saturation (S) and the value (V) of red, and extracts a blue pixel from the image using the threshold values of the hue (H), the saturation (S) and the value (V) of blue.

The color extraction section 13 extracts the green area, the red area and the blue area by performing labeling processing for the green pixels, the red pixels and the blue pixels, respectively. The color extraction section 13 may eliminate noise areas by performing morphological dilation and erosion processing and performing filtering processing depending on the size of the area for the respective extracted green area, red area and blue area.

In the case that the red area, the green area and the blue area extracted by the color extraction section 13 have a predetermined positional relationship, the judgement section 12 judges that the green area, the red area and the blue area are included in the image acquired by the image acquisition section 11. For example, in the case that the red area is present within a predetermined distance range from the position of the center of gravity of the green area on the image and that the blue area is present within a predetermined distance range from the position of the center of gravity of the red area on the image, the judgement section 12 judges that the green area, the red area and the blue area are included in the image. In the case that the judgement section 12 has judged that the green area, the red area and the blue area are included in the image, the judgement section 12 judges that a person is shown in the image and the person is present around the forklift 25.

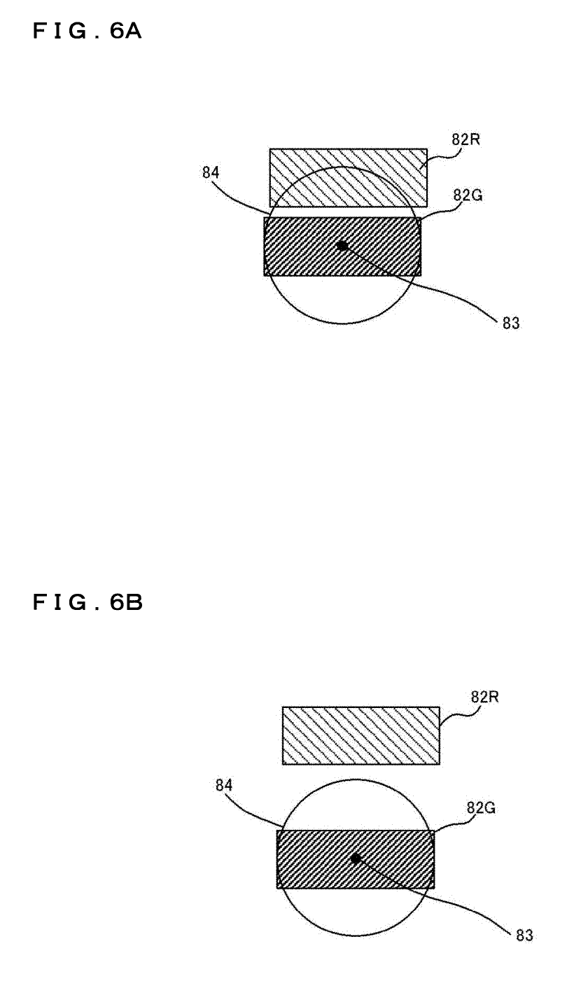

FIGS. 6A and 6B are views each showing an example including the green area and the red area on the image. As shown in FIG. 6A, in the case that a red area 82R is included inside the predetermined distance range 84 indicated by a circle with the position of the center of gravity 83 of a green area 82G as a center, it is judged that the red area 82R is present within the predetermined distance range 84 from the position of the center of gravity 83 of the green area 82G on the image.

On the other hand, as shown in FIG. 6B, in the case that the red area 82R is not included inside the predetermined distance range 84 indicated by the circle with the position of the center of gravity 83 of the green area 82G as a center, it is judged that the red area 82R is not present within the predetermined distance range 84 from the position of the center of gravity 83 of the green area 82G on the image.

The diameter of the circle of the predetermined distance range 84 may herein be made equal to, for example, the longest side of the green area 82G. In the case that the green area 82G is an area having a shape other than a rectangular shape, the length of the longest side of the circumscribed rectangle of the green area 82G may be used as the diameter of the circle of the predetermined distance range 84. However, the diameter may have values other than these values.

The notification section 14 performs notification processing depending on the result of the judgment processing of the judgement section 12. For example, in the case that the judgement section 12 has judged that a person is present around the forklift 25, the notification section 14 transmits a predetermined sound signal to the sound output device 30 via the communication I/F, thereby outputting a notification sound to the sound output device 30. Hence, a notification indicating that the person is present around the forklift 25 is given to the driver.

Furthermore, in the case that the judgement section 12 has made a similar judgement, the notification section 14 transmits a predetermined image signal to the display device 40 via the communication I/F, thereby making the display device 40 display an image indicating that the person has been detected. Hence, a notification indicating that the person is present around the forklift 25 is given to the driver.

Moreover, in the case that the judgement section 12 has made a similar judgement, the notification section 14 transmits information indicating that the person has been detected to the terminal device 50 via the communication I/F, thereby making the terminal device 50 perform the output processing of a sound or an image or perform the recording processing of log information. At the time, the notification section 14 may transmit information indicating the detection time.

On the basis of the pixel values on the color space and of the image of a reference label described later and attached to the forklift 25, the threshold value setting section 15 sets threshold values that are used when the color extraction section 13 extracts the respective color areas.

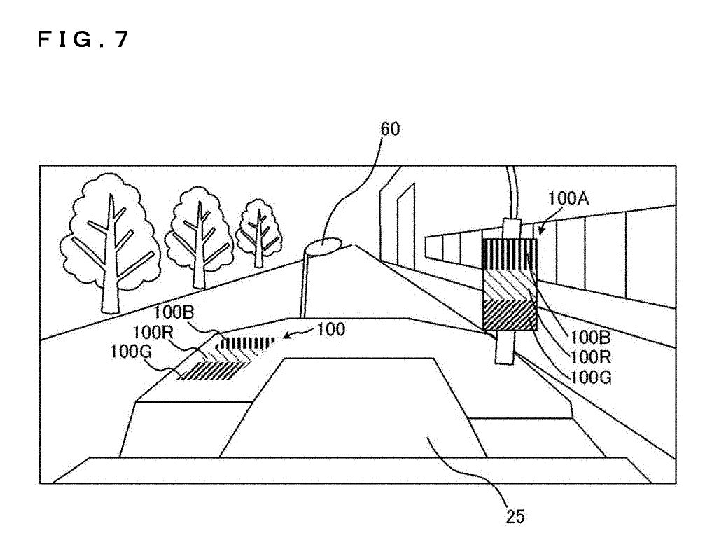

The reference label attached to the forklift 25 is herein described. FIG. 7 is a view showing an example of an image taken by the rearward monitoring camera 20. A reference label 100 is attached to a predetermined position on the vehicle body of the forklift 25. The reference label 100 is desirably a label made of the same material as that of the label 90A. The reference label 100 includes a blue label 100B, a red label 100R and a green label 100G. The colors of the red label 1008, the green label 100G and the blue label 100B are the same as the colors of the red label 90R, the green label 90G and the blue label 90B, respectively.

However, the attaching position of the reference label 100 is not limited to the vehicle body of the forklift 25; for example, as shown in FIG. 7, a reference label 100A may be attached to a position in an environment similar to the environment in which a person is present, such as a rod-like member for supporting the mirror 60. The reference label 100A includes the blue label 100B, the red label 100R, and the green label 100G as in the case of the reference label 100. In the case that the reference label 100A is provided on a face almost vertical to the ground as described above, the reference label 100A is less affected by sun light and illumination light than the reference label 100 attached to the vehicle body. Hence, in the case that the threshold values are set using the image obtained by imaging the reference label 100A, the threshold values can be set more accurately than in the case that the threshold values are set using the image obtained by imaging the reference label 100.

The threshold value setting section 15 sets the threshold values so that the blue label 100B, the red label 100R and the green label 100G in the image are surely detected. In other words, the threshold value setting section 15 sets the threshold values so that the pixel values on the HSV color space and of the respective color labels are included within the threshold values of the colors. The details of the method for setting the threshold values will be described later.

The vehicle state judgment section 16 acquires the detection result of the position of the shift lever from the shift sensor 112 via the communication I/F and judges whether the shift range is the R range (reverse range) on the basis of the acquired detection result of the position. In the case that the shift range is the R range and the forklift 25 is traveling, it is assumed that the forklift 25 is traveling rearward linearly or traveling rearward while turning or performing both the operations. However, in the case that the shift range is the R range and the brake is applied, the above-mentioned operation is not performed; however, when the brake is released, the above-mentioned operation is started, whereby the state of the above-mentioned case is assumed to be the preparation state of the above-mentioned operation.

The judgement result of the state of the vehicle by the vehicle state judgment section 16 is used to control the operation of the image processing device 10.

### <The Flow of the Processing of the Image Processing Device 10>

Next, the flow of the processing performed by the image processing device 10 will be described.

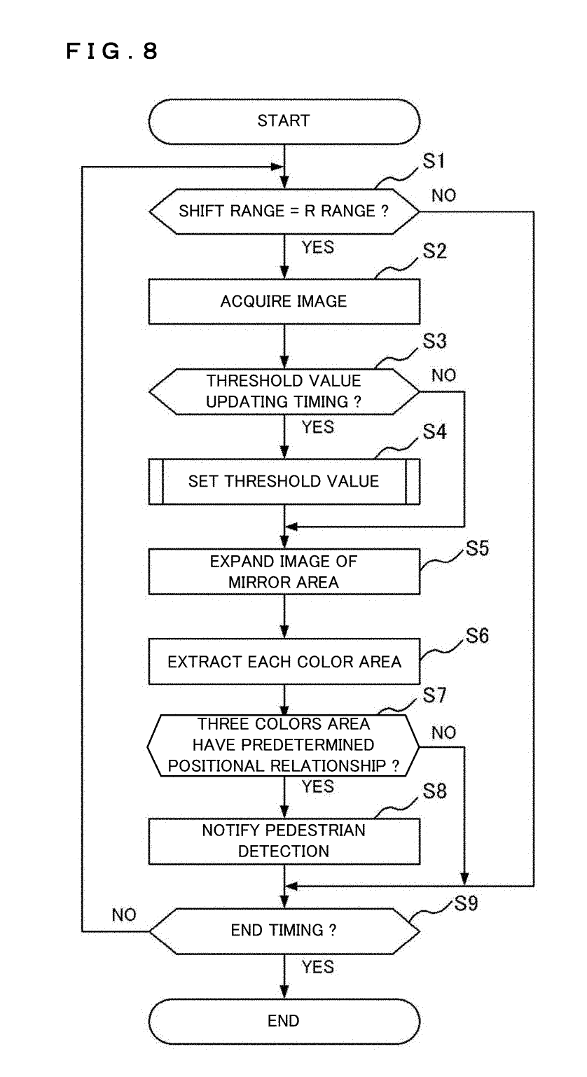

FIG. 8 is a flow chart of the processing performed by the image processing device 10 according to Embodiment 1.

On the basis of the detection result of the position of the shift lever by the shift sensor 112, the vehicle state judgement section 16 judges whether the shift range is the R range (at S1).

In the case that the vehicle state judgement section 16 has judged that the shift range is not the R range (NO at S1), the processing advances to step S9. For example, in the case that the shift range is the D range (drive range) and that the forklift 25 is traveling forward, the processing advances to step S9.

In the case that the vehicle state judgement section 16 has judged that the shift range is the R range (YES at S1), the image acquisition section 11 acquires the image taken by the rearward monitoring camera 20 (at S2).

The threshold value setting section 15 judges whether the present time is threshold value updating timing (at S3). In Embodiment 1, it is assumed that the threshold values are changed periodically at predetermined time intervals. For example, the threshold values may be changed at intervals of one minute. In other words, in the case that a predetermined time has passed after the threshold values were set at the last time or after the image processing device 10 started operation, the threshold value setting section 15 judges that the present time is the threshold updating timing; in the case that the predetermined time has not passed, the threshold value setting section 15 judges that the present time is not the threshold updating timing.

In the case that the present time is the threshold updating timing (YES at S3), the threshold value setting section 15 sets the threshold values (at S4). Threshold value setting processing (at S4) will be described later.

The judgement section 12 extracts the image of a mirror area from the image acquired by the image acquisition section 11 and expands the image at a predetermined expansion (for example, two times) (at S5). For example, the mirror 60 is shown in the image as shown in FIG. 7, and the judgement section 12 expands the image of the area of the mirror 60 at the predetermined expansion. In order that the mirror 60 having a small area reflects the wide-range blind spot area 22 having a wide range, a convex mirror is usually used as the mirror 60. There is a problem that the mirror image of a convex mirror is smaller than the image that is obtained by directly imaging the same object. Hence, the image of the area of the mirror 60 is expanded, whereby the judgement processing (area extraction processing) can be performed with the same accuracy as in the case that the same object is directly imaged. However, the processing (at S5) for expanding the image of the area of the mirror 60 is not essential.

The color extraction section 13 extracts the red area, the green area and the blue area from the image (at S6). At the time, the color extraction section 13 performs the area extraction processing for each of the image from which the mirror area is eliminated and the image in which the mirror area is expanded. Hence, the area of the person shown in the mirror 60 can be prevented from being doubly detected.

The judgement section 12 judges whether the red area, the green area and the blue area extracted by the color extraction section 13 have a predetermined positional relationship (at S7). For example, it is assumed that the red label 90R, the green label 90G and the blue label 90B shown in FIG. 4A have been extracted as the red area, the green area and the blue area, respectively. The judgement section 12 calculates the positions of the center of gravity of the red label 90R, the green label 90G and the blue label 90B. In the case that the distance between the position of the center of gravity of the green label 90G and the position of the center of gravity of the red label 90R is within a predetermined distance or less and that the distance between the position of the center of gravity of the red label 90R and the position of the center of gravity of the blue label 90B is within a predetermined distance or less, the judgement section 12 judges that the red label 90R, the green label 90G and the blue label 90B have a predetermined positional relationship.

In the case that the three color areas have the predetermined positional relationship (YES at S7), the judgement section 12 judges that a person is shown in the image, and the notification section 14 notifies that the person has been detected around the forklift 25 to the sound output device 30, the display device 40 and the terminal device 50 (at S8). The notification processing by the notification section 14 may be performed, for example, in the case that the distance between the rearward monitoring camera 20 and the person is within a predetermined distance (for example, 3 m). The distance between the rearward monitoring camera 20 and the person is herein determined on the basis of the size of the label 90A on the image extracted by the color extraction section 13. In other words, the notification section 14 may have a table indicating the relationship between the size of the label 90A and the distance and may determine the distance by referring to this table. Furthermore, in order to improve the accuracy of the detection, the notification section 14 may perform the notification processing only in the case that a person away from the rearward monitoring camera 20 within the predetermined distance is detected continuously a predetermined number of times (for example, five times) or more.

In the case that the three color areas do not have the predetermined positional relationship (NO at S7), the processing advances to step S9.

After the notification processing (at S8) is ended, in the case that the present time has become the end timing of the processing (YES at S9), the image processing device 10 ends the processing. The end timing of the processing is, for example, the timing at which the image processing device 10 receives the signal indicating that the engine of the forklift 25 is stopped.

In the case that the present time is not the end timing of the processing (NO at S9), the processing returns to step S1, and the processing of steps S1 to S8 is performed repeatedly.

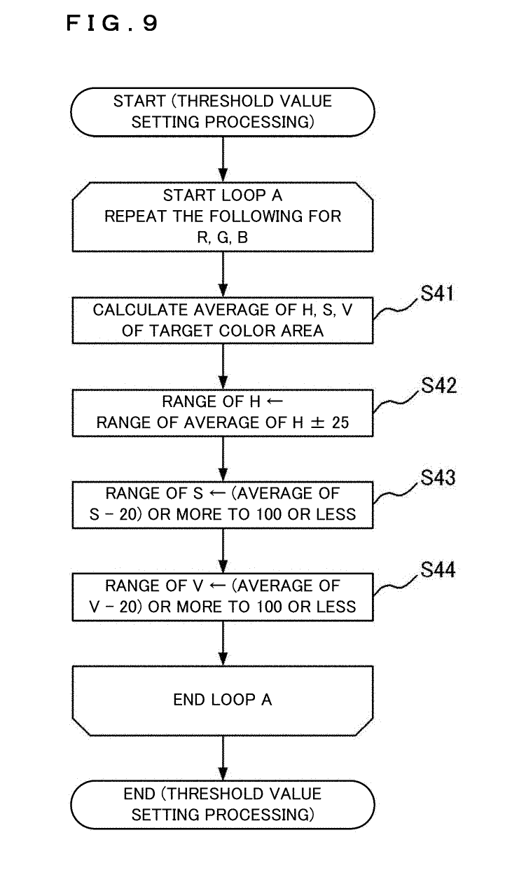

FIG. 9 is a flow chart showing the details of the threshold value setting processing (at S4 of FIG. 8).

The threshold value setting section 15 performs the processing of steps S41 to S44 (loop A), described later, for the respective colors of red, green and blue to be subjected to the threshold value setting processing.

Although red is taken as a target color in the following description, similar processing is also performed in the case that the target colors are green and blue.

The threshold value setting section 15 calculates the averages of the hue (H), the saturation (S) and the value (V) in the area of the red label 100R from the image acquired by the image acquisition section 11 (at S41). In other words, the threshold value setting section 15 converts the red component (R), the green component (G) and the blue component (B) on the RBG color space and of the respective pixels in the area of the red label 100R into the hue (H), the saturation (S) and the value (V) in the HSV color space, and calculates the averages of the hue (H), the saturation (S) and the value (V) in the area of the red label 100R. The conversion from the pixel values in the RGB space into the pixel values in the HSV color space is performed according to the formulas 1 to 3 described above.

The threshold value setting section 15 sets the range of the average of the hue (H)±25 as the range of the hue (H) of the red area (at S42).

The threshold value setting section 15 sets the range of (the average of the saturation (S)−20) or more to 100 or less as the range of the saturation (S) of the red area (at S43).

The threshold value setting section 15 sets the range of (the average of the value (V)−20) or more to 100 or less as the range of the value (V) of the red area (at S44).

Hence, the threshold value setting section 15 can set the threshold values of the hue (H), the saturation (S) and the value (V) on the basis of which the area of the red label 100R can be extracted.

### <Effects of Embodiment 1>

As described above, with Embodiment 1, the three color labels are disposed on the helmet 80 in the predetermined positional relationship. Furthermore, the judgement section 12 extracts the three color areas from the image taken by the rearward monitoring camera 20 and judges whether the three color areas are disposed in the predetermined positional relationship. Hence, the judgement section 12 judges whether a person is present around the forklift 25. The processing for extracting the color areas can be performed in the case that the color areas are projected on the rearward monitoring camera 20. Thus, even in the case that the person has changed his posture, he can be detected stably. Furthermore, unlike the technology described in Patent Document 2, the detection range of the person is not limited. Consequently, the person being present around the forklift 25 can be detected at an arbitrary position where the forklift 25 travels.

Moreover, in the case that the shift range is the R range, that is, in the case that the forklift 25 is traveling rearward linearly or traveling rearward while turning or performing both the operations, the image processing device 10 performs processing (image acquisition processing, judgement processing, notification processing, etc.) for detecting a person. Hence, in the case that a person is present behind the forklift 25, that is, in the blind spot of the driver, the image processing device 10 can appropriately give a notification to the driver.

What's more, even if the brake has been applied, in the case that the shift range is the R range, the image processing device 10 performs processing for detecting a person. Hence, in the case that a person is present in the blind spot of the driver immediately before the forklift 25 starts, a notification can be given to the driver appropriately.

Furthermore, in the case that the forklift 25 is traveling forward, the image processing device 10 is configured so as not to perform processing for detecting a person. In the case that the forklift 25 is traveling forward, it is not necessary to monitor the area behind the forklift 25. In other words, even if a person is present behind the forklift 25, the presence of the person is not required to be notified to the driver. Consequently, with this configuration, the fact that a person has been detected can be prevented from being unnecessarily notified to the driver.

Furthermore, the threshold value setting section 15 sets the threshold values on the basis of the pixel values of the reference label 100 that has been disposed in an environment similar to that of the label 90A placed on the helmet worn by a person. Consequently, the threshold values can be set accurately, whereby the color extraction section 13 can accurately extract the label 90A.

Moreover, after the judgement section 12 has expanded the image of the area of the mirror 60 in the image at a predetermined expansion, the area extraction processing for the respective colors by the color extraction section 13 and the judgment processing by the judgement section 12 are performed. In other words, even in the case that a person is shown over the mirror 60 that is installed on the forklift 25 to confirm the blind spot, the processing is performed after the image of the person has been expanded. Hence, the person being present in the blind spot area can be detected accurately. Although the judgment processing (area extraction processing) is performed after the mirror image of the mirror 60 has been expanded in Embodiment 1, the expansion of the image is not essential. In other words, the judgment processing (area extraction processing) may be performed without expanding the image of the area of the mirror 60.

What's more, the predetermined two or more color areas (the red label 90R, the green label 90G and the blue label 90B) are disposed on the label 90A in the predetermined positional relationship. Hence, in the case that the label 90A is placed on a person, the person can be detected by the image processing device 10.

Still further, in the label 90A, the clearance area 90S is provided between the color labels adjacent to each other. Hence, even in the case that disturbances occur in the image taken by the rearward monitoring camera 20 due to vibrations and the like during the traveling of the forklift 25, the color of a color label can be prevented from being mixed with the color of the color label adjacent thereto when the image is taken. Consequently, a person can be detected accurately by the image processing device 10.

### (Modification)

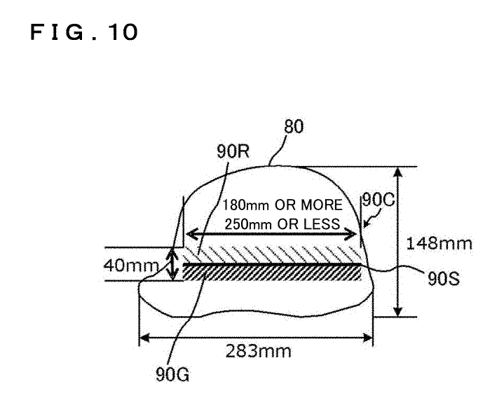

The labels to be attached to the helmet are not limited to those shown in FIGS. 4A and 4B. For example, the label may be composed of a two-color label. FIG. 10 is a side view showing a helmet worn by a person. As shown in FIG. 10, a label 90C composed of the red label 90R and the green label 90G is attached to the helmet 80. As shown in FIG. 10, in the case that the width of the helmet 80 is 283 mm and the height thereof is 148 mm, the width of the label 90C can be set to approximately 40 mm and the length thereof can be set to approximately 180 mm or more and 250 mm or less. The clearance area 90S is provided between the red label 90R and the green label 90G. Labels similar to the label 90C are also attached to the opposite side face, the front and rear sides, and the upper side of the helmet 80.

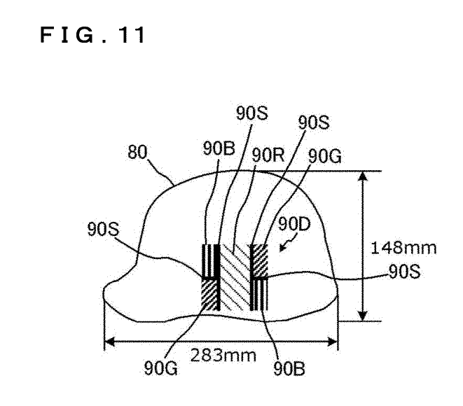

Furthermore, the shapes of the respective color labels to be attached to the helmet may be different for each color, and the arrangement of the labels may be made more complicated. FIG. 11 is a side view showing a helmet worn by a person. As shown in FIG. 11, a label 90D may be attached to the helmet 80. The label 90D includes the red label 90R disposed at the center, the green labels 90G disposed at positions adjacent to the upper right and lower left of the red label 90R, and the blue labels 90B disposed at positions adjacent to the upper left and lower right of the red label 90R. As clearly shown in FIG. 11, the size of the red label 90R is larger than the sizes of the blue labels 90B and the green labels 90G. Furthermore, the clearance areas 90S are provided between the respective labels. Moreover, labels similar to the label 90D are also attached to the opposite side face, the front and rear sides, and the upper side of the helmet 80.

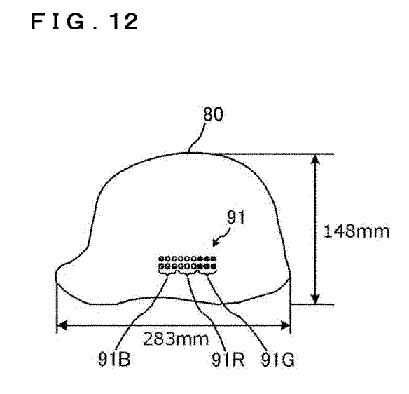

Furthermore, each of the color labels to be attached to the helmet may be composed of a light emitting element, such as an LED (Light Emitting Diode) or an organic EL (electroluminescence). FIG. 12 is a side view showing a helmet worn by a person. As shown in FIG. 12, a label 91 is placed on the helmet 80. The label 91 includes a blue label 91B composed of a blue LED, a red label 91R composed of a red LED, and a green label 91G composed of a green LED. Each LED is driven by a secondary battery, such as a lithium ion battery. Moreover, labels similar to the label 91 are also placed on the opposite side face, the front and rear sides, and the upper side of the helmet 80. Since the label 91 is composed of LEDs, the label 91 can be made easily recognizable even under environments in which illuminance is low, for example, at night or in cloudy weather.

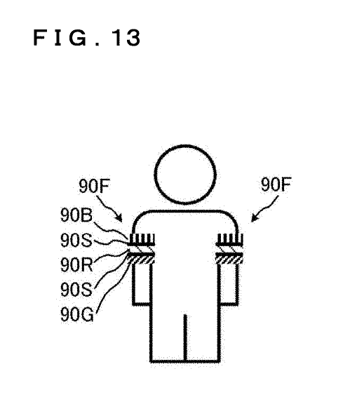

What's more, the labels may also be placed on clothes, armbands, etc. worn by a person, instead of the helmet 80. FIG. 13 is a front view of a person. This person wears armbands on which labels 90F are placed around his both arms. The label 90F is composed of the blue label 90B, the red label 90R and the green label 90G, and the clearance area 90S is provided between the respective labels.

### Embodiment 2

In Embodiment 1, the threshold value setting section 15 changes the threshold values periodically at predetermined time intervals; however, in Embodiment 2, the threshold value setting section 15 changes the threshold values in the case that a change in illuminance around the forklift 25 has been detected.

In the following descriptions, portions common to Embodiment 1 are not described repeatedly, and portions different from Embodiment 1 will be mainly described.

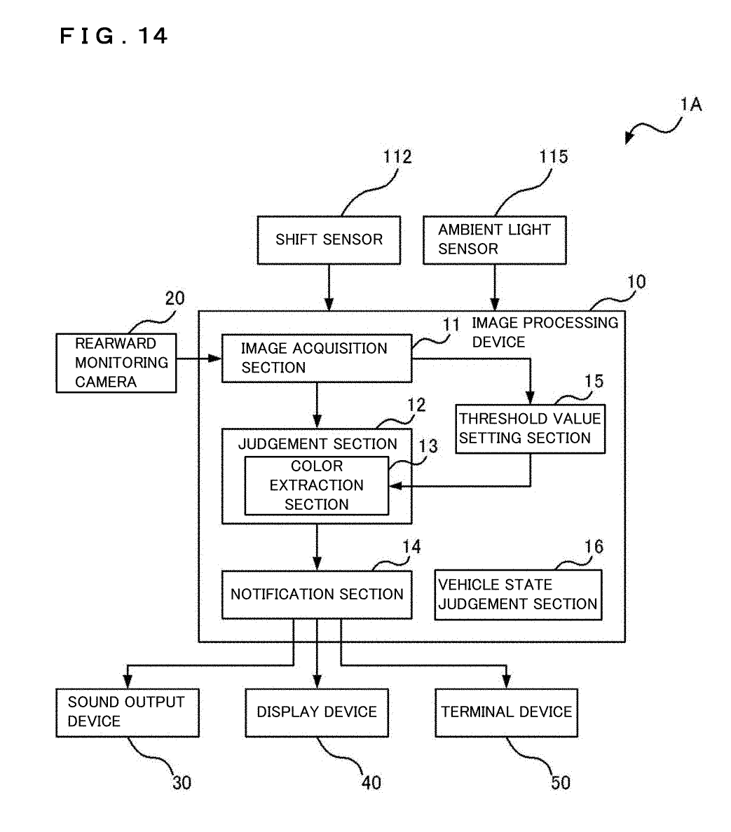

FIG. 14 is a block diagram showing a functional configuration of an image processing system according to Embodiment 2.

An image processing system 1 A is further equipped with an ambient light sensor 115 in the configuration of the image processing system 1 according to Embodiment 1 shown in FIG. 2. The ambient light sensor 115 is a sensor for detecting the illuminance around the forklift 25. The ambient light sensor 115 is configured so as to include, for example, a light receiving element. The ambient light sensor 115 is provided, for example, in the vicinity of the rearward monitoring camera 20. However, the illuminance around the forklift 25 may be judged from the image taken by the rearward monitoring camera 20 without using the ambient light sensor 115.

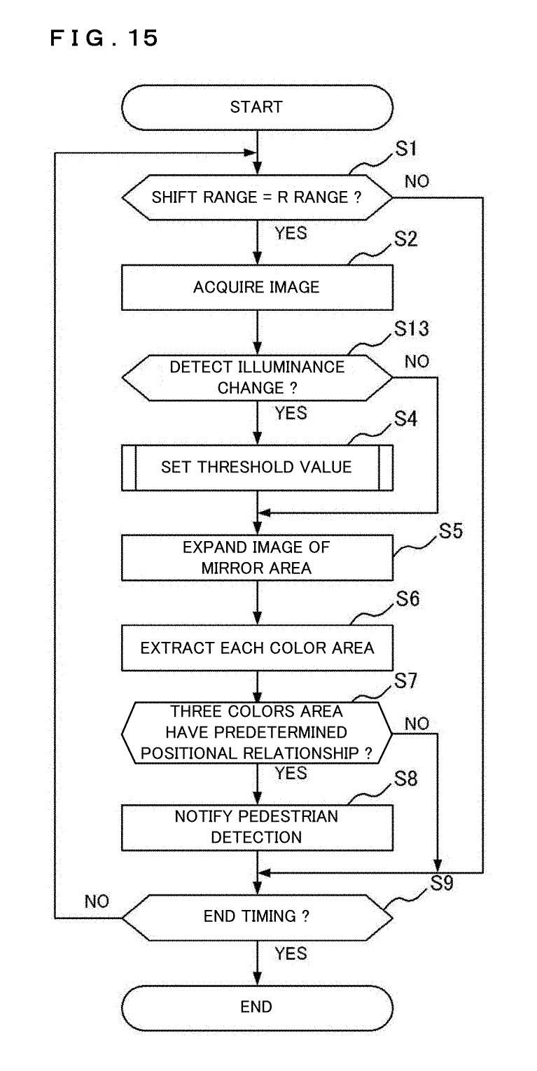

FIG. 15 is a flow chart of the processing performed by an image processing device 10 according to Embodiment 2.

The processing of steps S1, S2 and S4 to S9 is similar to the processing of steps S1, S2 and S4 to S9 shown in FIG. 8. In Embodiment 2, the processing of step S13 is performed instead of the processing of step S3 shown in FIG. 8.

In other words, the threshold value setting section 15 holds the illuminance detected by the ambient light sensor 115 and judges whether the illuminance around the forklift 25 has changed, on the basis of the illuminance difference between the current illuminance and the illuminance having been held at the time when the threshold value were set at the last time (at S13). In other words, in the case that the illuminance difference is not less than a predetermined illuminance threshold value, the threshold value setting section 15 judges that the illuminance has changed (detects the change in illuminance); and in the case that the illuminance difference is less than the predetermined illuminance threshold value, the threshold value setting section 15 judges that the illuminance has not changed (does not detect the change in illuminance).

In the case that the change in illuminance has been detected, the threshold value setting section 15 performs the threshold value setting processing (at S4).

At the first judgment processing (at S13) immediately after the start of the image processing device 10, the threshold value setting section 15 may be sure to detect the change in illuminance and then may perform the threshold value setting processing (at S4).

As described above, with Embodiment 2, in the case that the change in illuminance has been detected, the threshold values can be set. Hence, even in the case that the environment around the forklift 25 has changed, the color areas can be extracted accurately. Consequently, a person being present around the forklift 25 can be detected accurately.

### Embodiment 3

In Embodiment 1, the threshold value setting section 15 changes the threshold values periodically at predetermined time intervals; however, in Embodiment 3, the ambient light sensor 115 sets the threshold values on the basis of the position of the forklift 25.

In the following descriptions, portions common to Embodiment 1 are not described repeatedly, and portions different from Embodiment 1 will be mainly described.

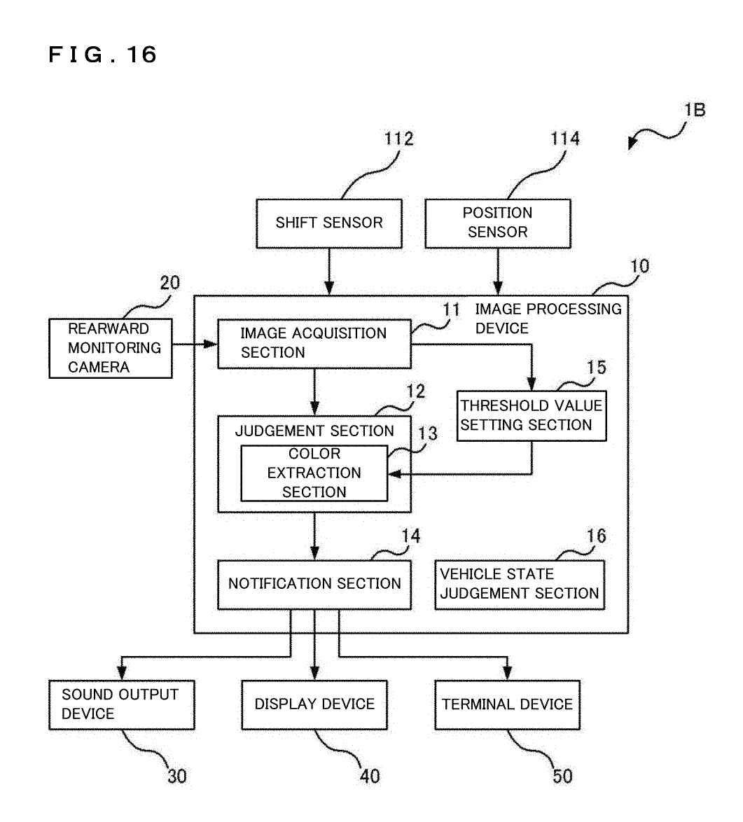

FIG. 16 is a block diagram showing a functional configuration of an image processing system according to Embodiment 3.

An image processing system 1 B is further equipped with a position sensor 114 in the configuration of the image processing system 1 according to Embodiment 1 shown in FIG. 2. The position sensor 114 is a sensor for detecting the position of the forklift 25. The position sensor 114 is configured so as to include, for example, a GPS (Global Positioning System) sensor. Although the position sensor 114 can be installed at an arbitrary position on the forklift 25, it is preferable that the position sensor should be installed at a position where the radio waves from the GPS satellites can be received easily.

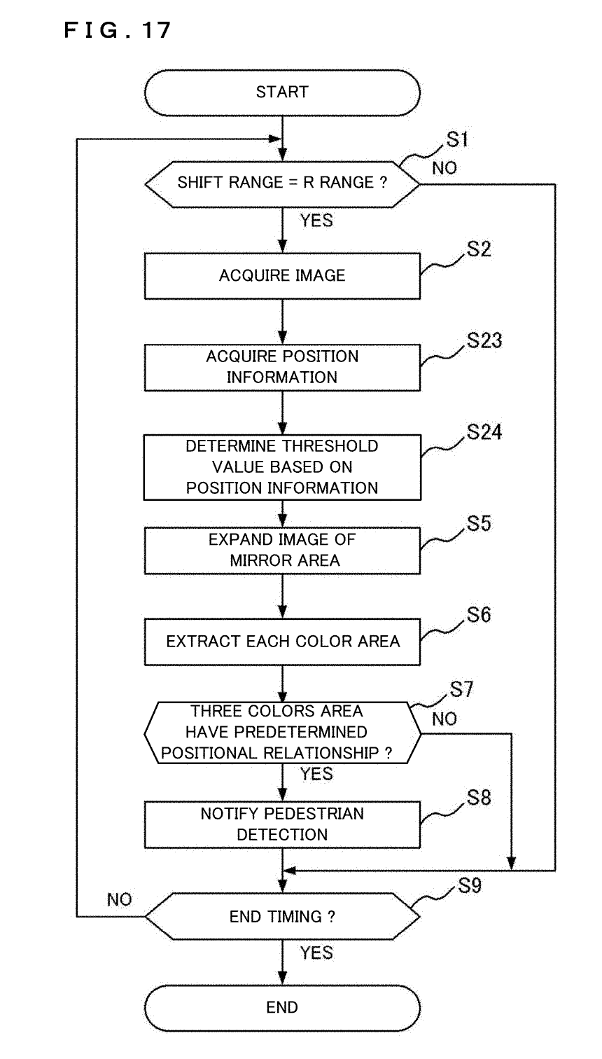

FIG. 17 is a flow chart of the processing performed by an image processing device 10 according to Embodiment 3.

The processing of steps S1, S2 and 5 to S9 is similar to the processing of steps S1, S2 and S5 to S9 shown in FIG. 8. In Embodiment 3, the processing of steps S23 and S24 is performed instead of the processing of steps S3 and S4 shown in FIG. 8.

In other words, the threshold value setting section 15 acquires position information from the position sensor 114 (at S23). The position information is, for example, information indicating the latitude and longitude of the forklift 25.

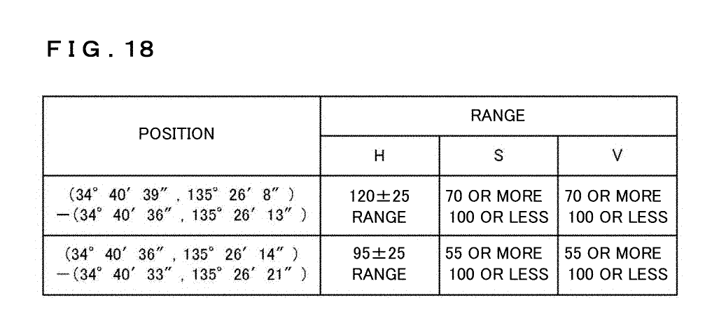

On the basis of the obtained position information, the threshold value setting section 15 determines the threshold values at the time when the respective color areas are extracted (at S24). FIG. 18 is a figure showing an example of a data table indicating the relationship between positions being held in the threshold value setting section 15 and the threshold values of the green areas. This data table indicates the threshold values of the hue (H), the saturation (S) and the value (V) for extracting the green area in the case that the forklift 25 is present within the position indicated by the data table.

For example, in the case that the position information (longitude, latitude) acquired from the position sensor 114 is within the range of (34° 40′39″, 135°26′8″) to (34°40′36″, 135°26′13″), the threshold value setting section 15 sets a range of 120±25 as the range of the hue (H) of the green area, sets a range of 70 or more to 100 or less as the range of the saturation (S) of the green area, and sets a range of 70 or more to 100 or less as the range of the value (V) of the green area.

Also for the red area and the blue area, the threshold value setting section 15 holds a data table indicating the relationship between the position and the threshold value in a similar way, and sets the threshold values of the red area and the blue area on the basis of the position information acquired from the position sensor 114.

As described above, with Embodiment 3, the threshold values can be set on the basis of the position of the forklift 25. Hence, for example, the threshold values in the case that the forklift 25 is traveling indoors can be changed so as to be different from the threshold values in the case that the forklift 25 is traveling outdoors. Hence, even in the case that the environment around the forklift 25 has changed, the color areas can be extracted accurately. Consequently, a person being present around the forklift 25 can be detected accurately.

### Embodiment 4

In Embodiments 1 to 3, an example in which a person being present behind the forklift 25 is detected has been described. In Embodiment 4, an example in which not only a person being present behind the forklift 25 but also another person being present ahead of the forklift 25 are detected will be described.

In the following descriptions, portions common to Embodiments 1 to 3 are not described repeatedly, and portions different from Embodiments 1 to 3 will be mainly described.

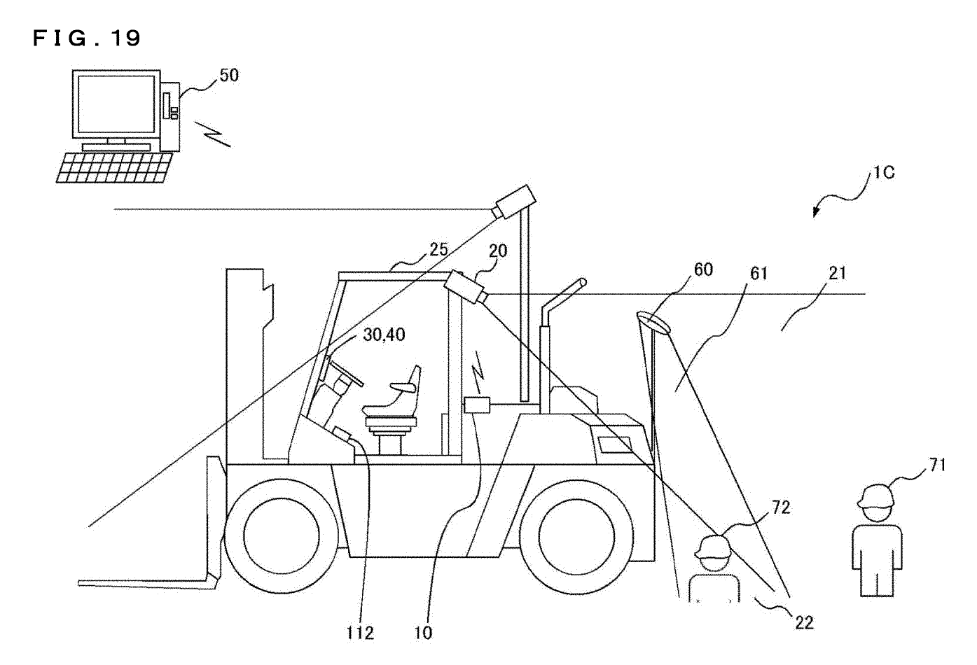

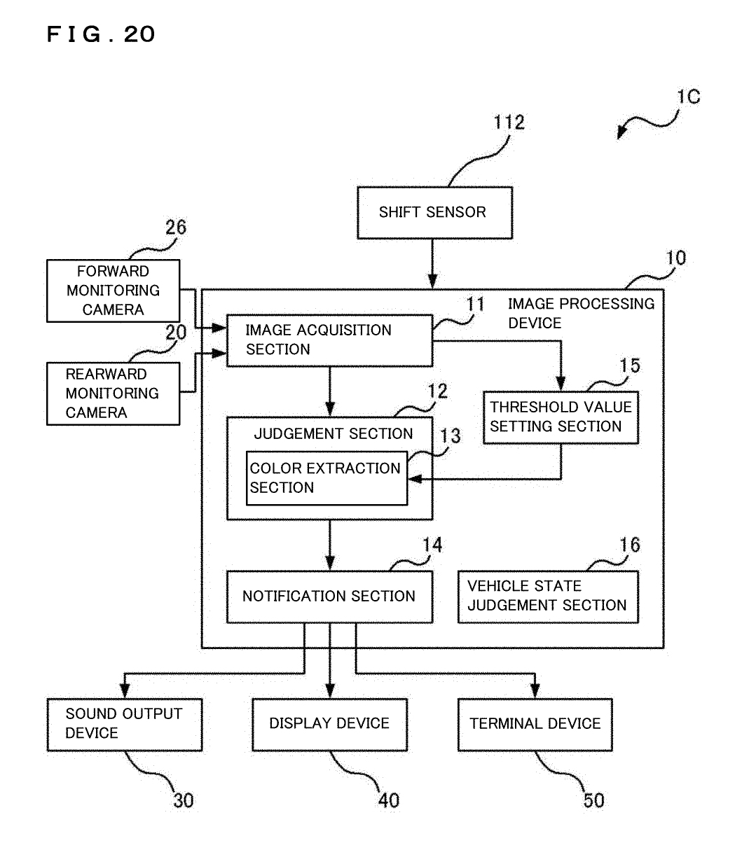

FIG. 19 is a view showing an installation example of an image processing system according to Embodiment 4. FIG. 20 is a block diagram showing a functional configuration of an image processing system according to Embodiment 4.

An image processing system 1C is further equipped with a forward monitoring camera 26 in the configuration of the image processing system 1 according to Embodiment 1 shown in FIG. 2.

The forward monitoring camera 26 constituting an imaging section together with the rearward monitoring camera 20 is installed, for example, at a position where the area ahead of the forklift 25 can be imaged (for example, a rod-like jig provided on the forklift 25) and is used to take images ahead of the forklift 25. The camera lens of the forward monitoring camera 26 is, for example, a super-wide angle lens having a field angle of 150° or more.

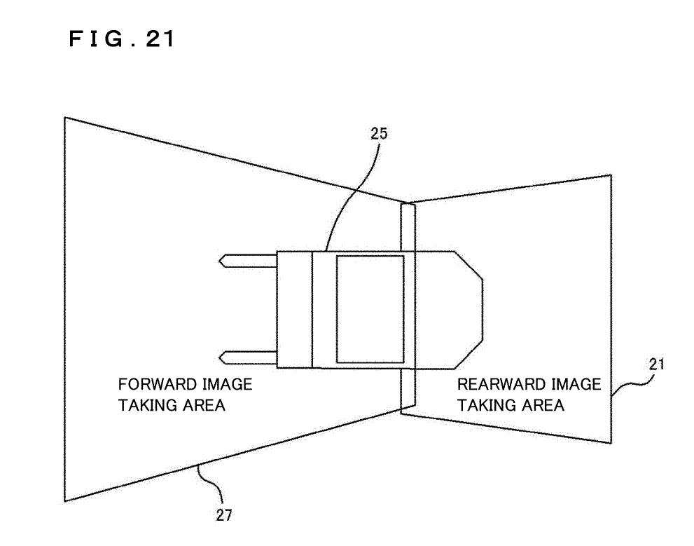

FIG. 21 is a schematic view showing the forklift 25 as viewed from above. In FIG. 21, the left side is the area ahead of the forklift 25, and the right side is the area behind the forklift 25. As shown in FIG. 21, the forward image taking area 27 to be monitored by the forward monitoring camera 26 and the rearward image taking area 21 to be monitored by the rearward monitoring camera 20 are set ahead of and behind the forklift 25, respectively. The rearward image taking area 21 has been described in Embodiment 1. The forward image taking area 27 is set, for example, so as to include the movable range of the forklift 25 in two seconds in the case that the forklift 25 travels at the maximum speed of 10 km/h. In other words, the forward monitoring camera 26 is set at the position where the image of the forward image taking area 27 can be taken. Hence, the forward monitoring camera 26 can take the image of a person being present inside the forward image taking area 27. The reason for this setting of the forward image taking area 27 is that it is assumed that the driver can stop the forklift 25 within two seconds after the driver found the person. Although a monocular camera is assumed to be used as the forward monitoring camera 26, a multiple camera, such as a stereo camera may also be used.

The image acquisition section 11 provided in the image processing device 10 acquires images taken by the forward monitoring camera 26 or images taken by the rearward monitoring camera 20 via the communication I/F.

The vehicle state judgment section 16 performs the following processing in addition to the judgment processing described in Embodiment 1. In other words, the vehicle state judgment section 16 acquires the detection result of the position of the shift lever from the shift sensor 112 via the communication I/F and judges whether the shift range is the D range on the basis of the acquired detection result of the position. In the case that the shift range is the D range and the forklift 25 is traveling, it is assumed that the forklift 25 is traveling forward linearly or traveling forward while turning or performing both the operations. However, in the case that the shift range is the D range and the brake is applied, the above-mentioned operation is not performed; however, when the brake is released, the above-mentioned operation is started, whereby the state of the above-mentioned case is assumed to be the preparation state of the above-mentioned operation.

Next, the flow of the processing performed by the image processing device 10 will be described.

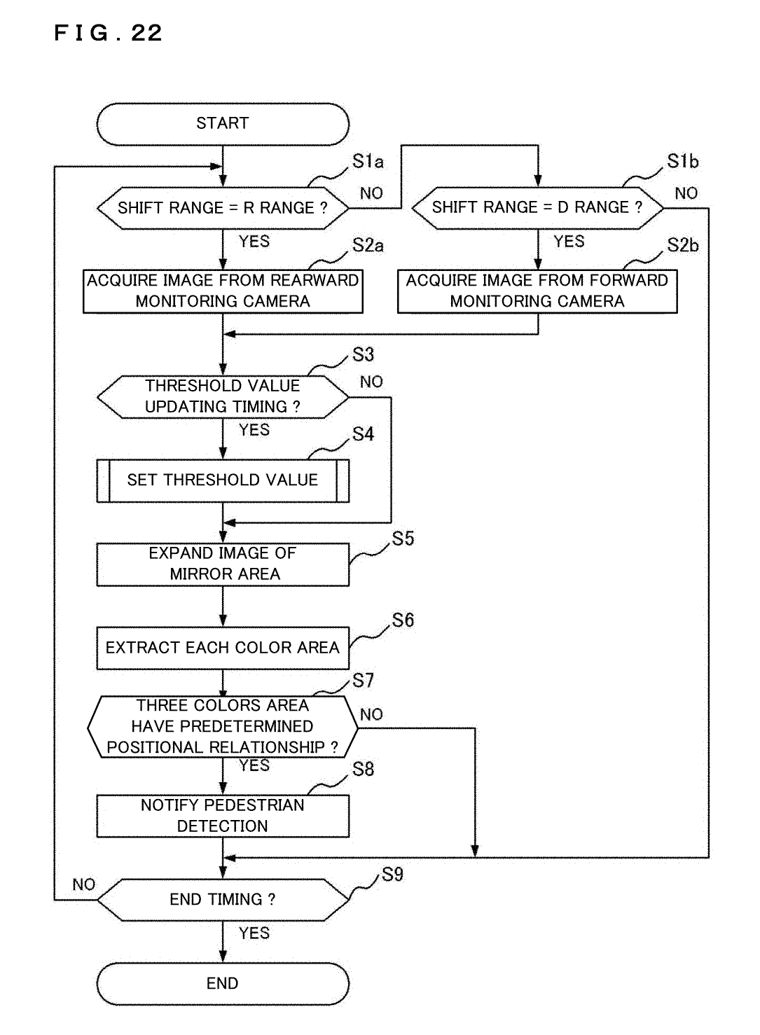

FIG. 22 is a flow chart of the processing performed by the image processing device 10 according to Embodiment 4. On the basis of the detection result of the position of the shift lever by the shift sensor 112, the vehicle state judgement section 16 judges whether the shift range is the R range (at S1a).

In the case that the vehicle state judgement section 16 has judged that the shift range is the R range (YES at S1a), the image acquisition section 11 acquires the image taken by the rearward monitoring camera 20 (at S2a). After that, the processing of S3 to S9 is performed for the image taken by the rearward monitoring camera 20. The processing of S3 to S9 is the same as described in Embodiment 1.

In the case that the vehicle state judgement section 16 has judged that the shift range is not the R range (NO at S1a), the vehicle state judgement section 16 judges whether the shift range is the D range on the basis of the detection result of the position of the shift lever (at S1b). However, it may be assumed that the shift range for forward movement, such as the L range or the 2nd range, is included in the D range. In other words, in the case that the shift range is the shift range for forward movement, such as the L range, the vehicle state judgement section 16 may judge that the shift range is the D range.

In the case that the vehicle state judgement section 16 has judged that the shift range is the D range (YES at S1a), the image acquisition section 11 acquires the image taken by the forward monitoring camera 26 (at S2b). After that, the processing of steps S3 to S9 is performed for the image taken by the forward monitoring camera 26. The processing of steps S3 to S9 is the same as described in Embodiment 1, except that the image to be processed is the image taken by the forward monitoring camera 26. Hence, in the case that a pedestrian is present inside the forward image taking area 27 of the forward monitoring camera 26, the pedestrian can be detected, and the result of the detection of the pedestrian can be notified to the driver.

In the case that the vehicle state judgment section 16 has judged that the shift range is neither the R range nor the D range (NO at S1b), the processing advances to step S9. For example, in the case that the shift range is the P range and the forklift 25 is stopping, the processing advances to step S9.

As described above, with Embodiment 4, in the case that the forklift 25 is moving forward, processing (image acquisition processing, judgement processing, notification processing, etc.) for detecting a person is performed for the image of the area ahead of the forklift 25 taken by the forward monitoring camera 26. Hence, a person being present ahead of the forklift 25 can be detected. Furthermore, in the case that a person is present ahead of the forklift, a notification can be given to the driver appropriately. Hence, the forklift 25 can be prevented preliminarily from making contact with the person being present around the forklift 25.

### <Supplementary Note>

Although the image processing systems 1 according to the embodiments of this disclosure have been described above, this disclosure is not limited to the embodiments.

For example, with the above-mentioned embodiments, it is assumed that the label is placed on a person and that the image processing device 10 detects the person; however, the label may be placed on an object other than a person. For example, the label may be attached to the vicinity of a place where the forklift 25 is prohibited to enter, whereby the image processing device 10 may detect that the forklift 25 has approached the place. Hence, the fact that the forklift 25 has approached the entry prohibited place can be notified, for example, to the driver.

Furthermore, although the color extraction section 13 of the above-mentioned image processing device 10 has extracted the color areas by subjecting the hue (H), the saturation (S) and the value (V) on the HSV color space to the threshold value processing, the objects to be subjected to the threshold value processing are not limited to the hue (H), the saturation (S) and the value (V) on the HSV color space. For example, the colors of the respective coordinates on an image may be represented by the hue (H), the value (V) and the chroma (C) in the Munsell color system, and color areas may be extracted by subjecting the hue (H), the value (V) and the chroma (C) to the threshold value processing. Moreover, the color areas may be extracted by subjecting the red components (R), the green components (G) and the blue components (B) of the respective coordinates on the image to the threshold value processing.

Furthermore, the above-mentioned label to be placed on a person or the like may be configured as described below.

In other words, the label is an object to be judged by the above-mentioned image processing device 10 whether the predetermined two or more color areas are included in the label,

the predetermined two or more color areas are disposed in the predetermined positional relationship,

the predetermined two or more color areas include a first color label, a second color label and a third color label,

the color of the first color label has the hue (H) in a range of 10P to 7.5YR, the value (V) in a range of 3 or more, and the chroma (C) in a range of 2 or more in the Munsell color system, the color of the second color label has the hue (H) in a range of 2.5GY to 2.5BG, the value (V) in a range of 3 or more, and the chroma (C) in a range of 2 or more in the Munsell color system, and

the color of the third color label has the hue (H) in a range of 5BG to 5P, the value (V) in a range of 1 or more, and the chroma (C) in a range of 1 or more in the Munsell color system.

Moreover, part or whole of the components constituting the above-mentioned image processing device 10 may be composed of a single system LSI. The system LSI is a super-multifunctional LSI manufactured by integrating a plurality of component sections on a single chip, more specifically, a computer system composed of a microprocessor, ROM and RAM. A computer program is stored in the RAM. The microprocessor operates according to the computer program, whereby the system LSI performs the functions thereof.

Furthermore, the computer program for making the computer function as the image processing device 10 may be recorded on computer-readable non-transitory recording media, such as a hard disk drive, a CD-ROM and a semiconductor memory. The computer program may be transmitted via an electric communication line, a wireless or wired communication line, a network typified by the Internet, data broadcasting, etc.

Moreover, the respective steps included in the above-mentioned computer program may be performed by a plurality of computers. What's more, the above-mentioned embodiments and the above-mentioned modification may be combined mutually.

The embodiments having been disclosed this time are to be considered exemplary and nonrestrictive in all respects. The range of this disclosure is intended to include, instead of the above-mentioned meanings, all the modifications within the meanings and ranges mentioned in the claims and being equivalent to the claims.

### DESCRIPTION OF REFERENCE NUMERALS AND SIGNS

1, 1A, 1B, 1C image processing system

10 image processing device

11 image acquisition section

12 judgement section

13 color extraction section

14 notification section

15 threshold value setting section

16 vehicle state judgment section

20 rearward monitoring camera

21 rearward image taking area

22 blind spot area

25 forklift

26 forward monitoring camera

27 forward image taking area

30 sound output device

40 display device

50 terminal device

60 mirror

61 rearward image taking area

71, 72 person

80 helmet

82R red area

82G green area

83 position of the center of gravity

84 predetermined distance range

90A, 90C, 90D, 90F, 91 label

90B, 91B, 100B blue label

90G, 91G, 100G green label

90R, 91R, 100R red label

90S clearance area

100, 100A reference label

112 shift sensor

114 position sensor

115 ambient light sensor

What is claimed is:

1-12. (canceled)

13. An image processing device comprising:
an image acquisition section for acquiring an image taken by an imaging section mounted on a vehicle categorized as an industrial vehicle or a vehicle-type construction machine,
a judgement section for performing judgment processing as to whether predetermined two or more color areas having a predetermined positional relationship are included in the image taken by the image acquisition section, and
a notification section for performing notification processing depending on the result of the judgment processing of the judgement section.

14. The image processing device according to claim 13, wherein
the imaging section includes a rearward monitoring camera, which is installed at the position on the vehicle where the area behind the vehicle is allocated as the imaging area thereof,
the image acquisition section acquires the image of the area behind the vehicle taken by the rearward monitoring camera, and
the judgement section stops the judgment processing for the image of the area behind the vehicle in the case that the vehicle is traveling forward.

15. The image processing device according to claim 14, wherein
the imaging section further includes a forward monitoring camera, which is installed at the position on the vehicle where the area ahead of the vehicle is allocated as the imaging area thereof,
the image acquisition section further acquires the image of the area ahead of the vehicle taken by the forward monitoring camera, and
the judgement section further performs the judgment processing for the image of the area ahead of the vehicle in the case that the vehicle is traveling forward.

16. The image processing device according to claim 13, wherein
the judgement section includes a color extraction section for extracting the predetermined two or more color areas on the basis of pixel values on a predetermined color space and of the respective pixels constituting the image and predetermined threshold values,
the image acquisition section acquires an image, taken by the imaging section, of a reference label having the predetermined two or more colors and placed at a predetermined position of the vehicle, and
the image processing device is further equipped with a threshold value setting section for setting the predetermined threshold values on the basis of the pixel values on the color space and of the image of the reference label.

17. The image processing device according to claim 14, wherein
the judgement section includes a color extraction section for extracting the predetermined two or more color areas on the basis of pixel values on a predetermined color space and of the respective pixels constituting the image and predetermined threshold values,
the image acquisition section acquires an image, taken by the imaging section, of a reference label having the predetermined two or more colors and placed at a predetermined position of the vehicle, and
the image processing device is further equipped with a threshold value setting section for setting the predetermined threshold values on the basis of the pixel values on the color space and of the image of the reference label.

18. The image processing device according to claim 15, wherein
the judgement section includes a color extraction section for extracting the predetermined two or more color areas on the basis of pixel values on a predetermined color space and of the respective pixels constituting the image and predetermined threshold values,
the image acquisition section acquires an image, taken by the imaging section, of a reference label having the predetermined two or more colors and placed at a predetermined position of the vehicle, and
the image processing device is further equipped with a threshold value setting section for setting the predetermined threshold values on the basis of the pixel values on the color space and of the image of the reference label.

19. The image processing device according to claim 16, wherein
the threshold value setting section sets the predetermined threshold values in the case that a change in illuminance around the vehicle is detected.

20. The image processing device according to claim 13, wherein
the judgement section includes a color extraction section for extracting the predetermined two or more color sections on the basis of the values on a predetermined color space and of the respective pixels constituting the image and predetermined threshold values, and
the image processing device is further equipped with a threshold value setting section for setting the predetermined threshold values on the basis of the position of the vehicle.

21. The image processing device according to claim 14, wherein
the judgement section includes a color extraction section for extracting the predetermined two or more color sections on the basis of the values on a predetermined color space and of the respective pixels constituting the image and predetermined threshold values, and
the image processing device is further equipped with a threshold value setting section for setting the predetermined threshold values on the basis of the position of the vehicle.

22. The image processing device according to claim 15, wherein
the judgement section includes a color extraction section for extracting the predetermined two or more color sections on the basis of the values on a predetermined color space and of the respective pixels constituting the image and predetermined threshold values, and
the image processing device is further equipped with a threshold value setting section for setting the predetermined threshold values on the basis of the position of the vehicle.

23. The image processing device according to claim 13, wherein
of the images acquired by the image acquisition section, the image of a mirror area that is taken by imaging the mirror installed on the vehicle is subjected to the judgment processing by the judgement section.

24. An image processing system comprising:
a label, which is placed on an object to be detected and on which predetermined two or more color areas are disposed in a predetermined positional relationship, and
an image processing device for detecting the object to be detected, wherein
the image processing device has:
an image acquisition section for acquiring an image taken by an imaging section mounted on a vehicle categorized as an industrial vehicle or a vehicle-type construction machine,
a judgement section for performing judgment processing as to whether the predetermined two or more color areas are included in the image taken by the image acquisition section, and
a notification section for giving a notification depending on the result of the judgment processing of the judgement section.

25. A computer readable non-transitory recording medium recording an image processing program making a computer function as:
an image acquisition section for acquiring an image taken by an imaging section mounted on a vehicle categorized as an industrial vehicle or a vehicle-type construction machine,
a judgement section for performing judgment processing as to whether predetermined two or more color areas are included in the image taken by the image acquisition section, and
a notification section for performing notification processing depending on the result of the judgment processing of the judgement section.

26. A label to be subjected to judgment processing by the image processing device according to claim 13 as to whether predetermined two or more color areas are included, wherein
the predetermined two or more color areas are disposed in a predetermined positional relationship.

27. The label according to claim 26, wherein
a predetermined clearance is provided between the respective color areas.

28. The label according to claim 26, wherein
the respective color areas are composed of fluorescent tapes, fluorescent paint or light emitting elements.
